(19) United States
(12) Patent Application Publication
(10) Pub. No.: US 2008/0193037 A1
(43) Pub. Date: Aug. 14, 2008

(54) DEMOSAICKING METHODS AND APPARATUS

(75) Inventors: Oscar Chi Lim Au, Hong Kong (CN); Carman Ka Man Yuk, Hong Kong (CN)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: THE HONG KONG UNIVERSITY OF SCIENCE AND TECHNOLOGY, Hong Kong (CN)

(21) Appl. No.: 12/028,639

(22) Filed: Feb. 8, 2008

Related U.S. Application Data
(60) Provisional application No. 60/900,236, filed on Feb. 9, 2007.

(51) Int. Cl. G06K 9/40; H04N 5/228; G06K 9/32

(52) U.S. Cl. 382/260; 348/222.1; 382/300; 348/E05.031

(57) ABSTRACT

A method includes performing a single pass filtering that integrates a first pass demosaicking and a second pass demosaicking into a single pass operation. The method can include interpolating in a vertical direction as well as interpolating in a horizontal direction. The vertical interpolation can be compared with the horizontal interpolation and one interpolation can be selected. The method can include comparing a vector with a plurality of neighbor vectors and selecting the direction with the smallest vector difference. A digital camera is provided that includes at least one data store for storing a plurality of video images, and a host system that processes the video images by performing a single pass filtering that integrates a first pass demosaicking and a second pass demosaicking into a single simple pass (SP) filtering operation. The host system compares a vertical interpolation with a horizontal interpolation and selects one interpolation, in another exemplary non-limiting embodiment. The host system can compares a vector with a plurality of neighbor vectors and selecting the direction with the smallest vector difference. In another exemplary non-limiting embodiment, the host system interpolates in a Kᵣ space and a K_{b} space using a G channel.

### CROSS REFERENCE TO RELATED APPLICATIONS

This application claims the benefit of is a continuation of U.S. 60/900,236, filed on Feb. 9, 2007, entitled “Detailed description of Soft-decision color demosaicking with simple pass and direction vector selection,” the entirety of which is incorporated herein by reference.

### TECHNICAL FIELD

The subject disclosure relates to image capture device optimizations for interpolating processes that efficiently processes video data according to a processing model.

### BACKGROUND

Digital cameras are widely used as digital image capture devices nowadays. Electronic products, such as mobile phone and pocket PC, are also typically equipped with digital image capture devices.

Some conventional systems have three charge-coupled devices (CCDs) to capture digital images with red (R), green (G), and blue (B) colors. Instead of using three CCDs, one CCD with color filter array (CFA) can be used in order to reduce the production cost. A frequently adopted pattern for R, G, B pixelation in digital cameras is referred to as a Bayer CFA 100 as shown in FIG. 1. In the pattern of blocks 102 forming rows and columns, for instance, the G channel provides twice the sampling frequencies over the R and B channels. As such, only one color component is captured at every pixel. The process of reconstructing full color images (with three colors at every pixel) from such captured images is called demosaicking or color interpolation.

Bilinear interpolation is a simple demosaicking method, but the reconstructed images are blurred and many color artifacts are introduced. Thus, a variety of conventional demosaicking approaches have been proposed to improve the quality of reconstructed images. For instance, a gradient-corrected bilinear interpolation method has been proposed with a gain parameter to control how much correction is applied. Another interpolation based conventional system proposes a covariance-based adaptation edge-directed interpolation. Based on the property that color differences Kᵣ (G−R) and K_{b} (G−B) are usually quite flat within small regions, interpolation has also been performed in Kᵣ and K_{b} space instead of solely R, G and B space. A correction process has also been proposed that applies to interpolation results as an attempt to achieve cost effective demosaicking. Primary-consistent soft-decision color demosaicking (PCSD) has also been proposed to maintain direction consistency during interpolation among colors for each pixel location. PCSD first interpolates the missing G elements vertically and horizontally. Then, the R and B elements are interpolated in vertical and horizontal directions using vertical and horizontal interpolated G values, respectively. However, PCSD implicates a two pass demosaicking operation, which introduces expensive use of computational computing resources.

The above-described deficiencies of current designs for demosaicking operations are merely intended to provide an overview of some of the problems of today's designs, and are not intended to be exhaustive. Other problems with the state of the art and corresponding benefits of the innovation may become further apparent upon review of the following description of various non-limiting embodiments of the innovation.

### SUMMARY

Demosaicking optimizations are provided for still and/or moving image (e.g., video) processes that efficiently generate viewable images. In various embodiments, the images created demonstrate performance gains in peak signal to noise ratio (PSNR).

In one exemplary non-limiting embodiment, a method includes performing a single pass filtering that integrates a first pass demosaicking and a second pass demosaicking into a single pass operation. The method can include interpolating in a vertical direction as well as interpolating in a horizontal direction. The vertical interpolation can be compared with the horizontal interpolation and one interpolation can be selected. The method can include comparing a vector with neighbor vectors and selecting a direction with the smallest vector difference.

In another exemplary non-limiting embodiment, a digital camera is provided. The digital camera includes a data store for storing video images, and a host system that processes the video images by performing a single pass filtering that integrates a first pass demosaicking and a second pass demosaicking into a single simple pass (SP) filtering operation. Optionally, the host system compares a vertical interpolation with a horizontal interpolation and selects one interpolation. The host system can compares a vector with neighbor vectors and select the direction with the smallest vector difference. In another exemplary non-limiting embodiment, the host system interpolates in a Kᵣ space and a K_{b} space using a G channel.

In another exemplary non-limiting embodiment, apparatus includes means for receiving video data, and means for performing a simple pass filtering that integrates a first pass demosaicking and a second pass demosaicking into a single operation.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the innovation in a simplified form as a prelude to the more detailed description that follows.

### BRIEF DESCRIPTION OF THE DRAWINGS

The various optimizations for image demosaicking are further described with reference to the accompanying drawings in which:

FIG. 1 illustrates a Bayer color filter array;

FIG. 2 illustrates a first arrangement of an array;

FIG. 3 illustrates a second arrangement of an array;

FIG. 4 illustrates a third arrangement of an array;

FIG. 5 illustrates a fourth arrangement of an array;

FIG. 6 illustrates a digital camera according to an illustrative embodiment;

FIG. 7 illustrates a first flow diagram showing an exemplary methodology for achieving demosaicking;

FIG. 8 illustrates a second flow diagram showing an exemplary methodology for achieving demosaicking;

FIG. 9 is a block diagram representing an exemplary non-limiting computing system or digital camera operating environment in which various embodiments described herein may be implemented;

FIG. 10 illustrates an overview of a network environment suitable for service by one or more embodiments described herein; and

FIGS. 11A and 11B illustrates some representative performance results of applying demosaicking according to one or more embodiments described herein, including an improved peak signal to noise ratio (PSNR).

### DETAILED DESCRIPTION

### Overview

As discussed in the background, some conventional systems have used a two pass demosaicking operation that utilizes more resources than desired and can at times be inefficient.

As mentioned, the most frequently adopted pattern in digital cameras is Bayer CFA as shown in FIG. 1. In the pattern, the G channel provides twice the sampling frequencies over the R and B channels. As such, only one color component is captured at every pixel. The process of reconstructing full color images (with three colors available at each pixel) from such partial capturing of images (sampling) is called demosaicking or color interpolation. A bilinear interpolation is one simple demosaicking method, but the reconstructed images are blurred and many color artifacts are induced. Thus, many demosaicking approaches are proposed to improve the quality of reconstructed images. In the bilinear interpolation two interpolations passes are made.

In the herein described methods and apparatus a simple pass (SP) filter is employed for interpolation such that the two-passes of demosaicking are effectively combined into one-pass. One exemplary non-limiting embodiment method is based on the soft-decision framework. Also described herein is a direction vector selection (DVS) process for choosing appropriate directions of interpolated signals. DVS helps to conserve direction consistency of interpolation and thus minimizes color artifacts that are almost always problematic.

The whole demosaicking process is based on soft-decision framework of PSCD with some modifications in several procedures. Both the vertical and horizontal interpolated values of G are first computed using the herein described simple pass (SP) filter that generates excellent reconstructed signals. Missing elements of R and B are then interpolated in Kᵣ and K_{b} spaces with the aid of G channel. After both the vertical and horizontal interpolated signals of R, G, and B are acquired, a direction of interpolated results in each pixel location is selected based on the herein described direction vector selection (DVS). Finally, a reconstructed image is obtained. The following details each procedure.

In the following explanation, R, G and B and are original color values obtained by CCD. R′, G′ and B′ are interpolated color values during the first-pass demosaicking while R″, G″ and B″ are interpolated color values during the second-pass demosaicking. The R, G, B R′, G′, B′, R″, G″ and B″ values are within 0 and 255 (8 bit), although other ranges can be employed. The subscripts of R, G, B R′, G′, B′, R″, G″ and B″, Kᵣ and K_{b} denote the pixel location in the figures while the superscripts of the missing elements denote their interpolation direction.

G channel is first interpolated to aid the later interpolation of R and B channels. Interpolation is performed in Kᵣ and K_{b} space and provides reasonable results. Thus, in one embodiment proposed herein missing G values are reconstructed in Kᵣ and K_{b} space, but in either the vertical or horizontal direction and with more precise approximation than was performed previously.

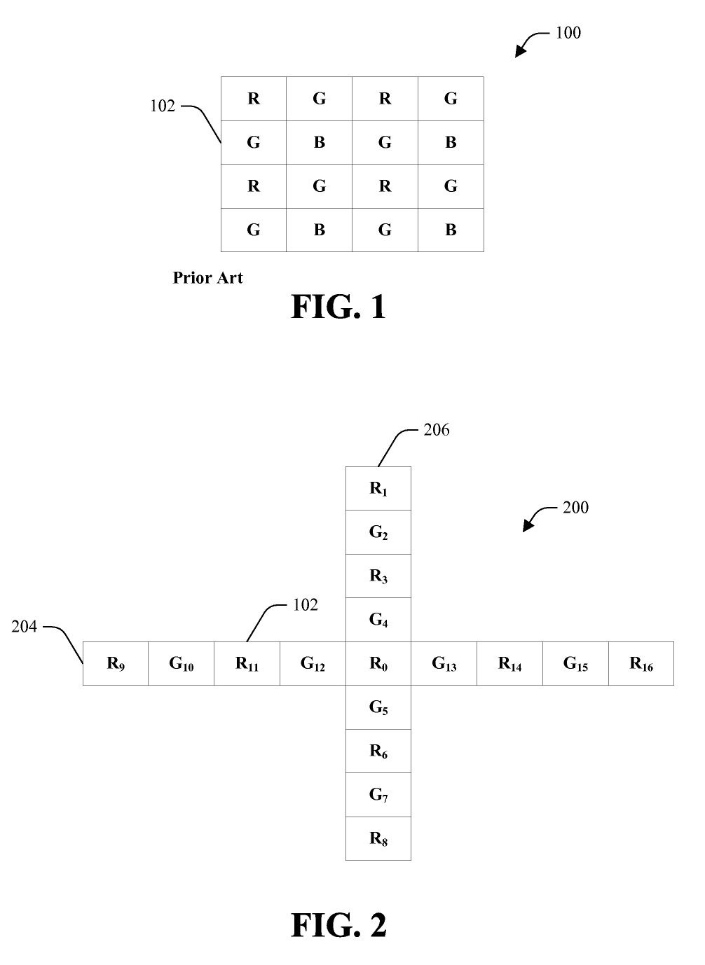

As mentioned, the missing G values are interpolated in either vertical or horizontal direction in Kᵣ and K_{b} space. For example, referring to FIG. 2, an array 200 of blocks 102 (representing pixels) are in a row 204 and a column 206. G′ can be interpolated in accordance with

$$\begin{matrix}\begin{matrix}{G}_{0}^{′ V} - {R}_{0} = {K}_{r 0} \\ = \frac{{K}_{r 4} + {K}_{r 5}}{2} \\ = \frac{( {G}_{4} - {\tilde{R}}_{4} ) + ( {G}_{5} - {\tilde{R}}_{5} )}{2}\end{matrix} & Eq . 1\end{matrix}$$

\tilde{R}₄ and \tilde{R}₅ do not exist, and therefore they are approximated with

$${\tilde{R}}_{4} = \frac{{R}_{3} + {R}_{0}}{2} and {\tilde{R}}_{5} = \frac{{R}_{6} + {R}_{0}}{2} .$$

It was found that using more precise approximations can interpolate a reconstructed image with better quality. As a result, it was suggested to perform the demosaicking once on the Bayer filtered image, and then use the interpolation results as the approximated values of the second demosaicking process. Quality of reconstructed images from two-pass demosaicking is better, but the complexity almost doubles that of one-pass demosaicking because the whole interpolation process is performed twice. The time delay is also doubled because the second demosaicking process has to be postponed until the first demosaicking process is completed. Thus, herein described is a simple pass (SP) to combine the two-pass together with one-pass demosaicking.

Derivation of interpolation of G will be discussed in the following. Considering R′, G′, and B′ at corresponding missing locations had been interpolated after the first-pass demosaicking with an approximation using neighbor averaging. During the second-pass demosaicking, if G₀″ at R₀ is interpolated vertically according to FIG. 2, by the assumption that Kᵣ is smooth along the edge, and thus

$$\begin{matrix}\begin{matrix}{G}_{0}^{″ V} - {R}_{0} = {K}_{r 0} \\ = \frac{{K}_{r 4} + {K}_{r 5}}{2} \\ = \frac{( {G}_{4} - {\tilde{R}}_{4} ) + ( {G}_{5} - {\tilde{R}}_{5} )}{2}\end{matrix} & Eq . 2\end{matrix}$$

then as discussed above, one can use results from first-pass demosaicking R′ as the approximation of \tilde{R}. Vertical interpolated values, R₄′^{V} and R₅′^{V}, are used because R₄′ and R₅′ should be interpolated along the same direction as G″ by the assumption that interpolation is along the edge. Therefore Eq. 2 becomes

$${G}_{0}^{″ V} - {R}_{0} = \frac{( {G}_{4} - {R}_{4}^{′ V} ) + ( {G}_{5} - {R}_{5}^{′ V} )}{2} \qquad Eq . 3$$

For (G₄−R₄′^{V}) and (G₅−R₅′^{V}) in Eq. 3, they are based on averaging Kᵣ of their top and bottom neighbor during first-pass demosaicking, and

$$\begin{matrix}\begin{matrix}{G}_{4} - {R}_{4}^{′ V} = {K}_{r 4} \\ = \frac{{K}_{r 3} + {K}_{r 0}}{2} \\ = \frac{( {G}_{3}^{′ V} - {R}_{3} ) + ( {G}_{0}^{′ V} - {R}_{0} )}{2}\end{matrix} & Eq . 4 \\ \begin{matrix}{G}_{5} - {R}_{5}^{′ V} = {K}_{r 5} \\ = \frac{{K}_{r 6} + {K}_{r 0}}{2} \\ = \frac{( {G}_{6}^{′ V} - {R}_{6} ) + ( {G}_{0}^{′ V} - {R}_{0} )}{2}\end{matrix} & Eq . 5\end{matrix}$$

G₀′^{V}, G₃′^{V}, and G₆′^{V} have been interpolated in the first pass as follows

$$\begin{matrix}{G}_{0}^{′ V} - {R}_{4} = \frac{( {G}_{4} - \frac{{R}_{3} + {R}_{0}}{2} ) + ( {G}_{5} - \frac{{R}_{6} + {R}_{0}}{2} )}{2} & Eq . 6 \\ {G}_{3}^{′ V} - {R}_{3} = \frac{( {G}_{2} - \frac{{R}_{1} + {R}_{3}}{2} ) + ( {G}_{4} - \frac{{R}_{3} + {R}_{0}}{2} )}{2} & Eq . 7 \\ {G}_{6}^{′ V} - {R}_{6} = \frac{( {G}_{5} - \frac{{R}_{0} + {R}_{6}}{2} ) + ( {G}_{7} - \frac{{R}_{6} + {R}_{8}}{2} )}{2} & Eq . 8\end{matrix}$$

After the substitution of (6), (7) and (8) into (4) and (5), and then the substitution of (4) and (5) into (3), one obtains the following,

$$\begin{matrix}{G}_{0}^{″ V} - {R}_{0} = \frac{1}{8} ( {G}_{2} + 3 {G}_{4} + 3 {G}_{5} + {G}_{7} ) - \frac{1}{16} ( {R}_{1} + 4 {R}_{3} + 6 {R}_{0} + 4 {R}_{6} + {R}_{8} ) & Eq . 9 \\ {G}_{0}^{″ H} - {R}_{0} = \frac{1}{8} ( {G}_{10} + 3 {G}_{12} + 3 {G}_{13} + {G}_{15} ) - \frac{1}{16} ( {R}_{0} + 4 {R}_{11} + 6 {R}_{0} + 4 {R}_{14} + {R}_{16} ) & Eq . 10\end{matrix}$$

One can see that (9) and (10) are simple pass filters that integrate the first and second pass of demosaicking together. Thus, one can apply them only once to obtain interpolation values of G″ as if the demosaicking process is performed twice. After this procedure, there are two interpolated G values for each missing G pixel location. Interpolation of missing G elements at B pixel locations is performed in a similar way by interchanging R with B.

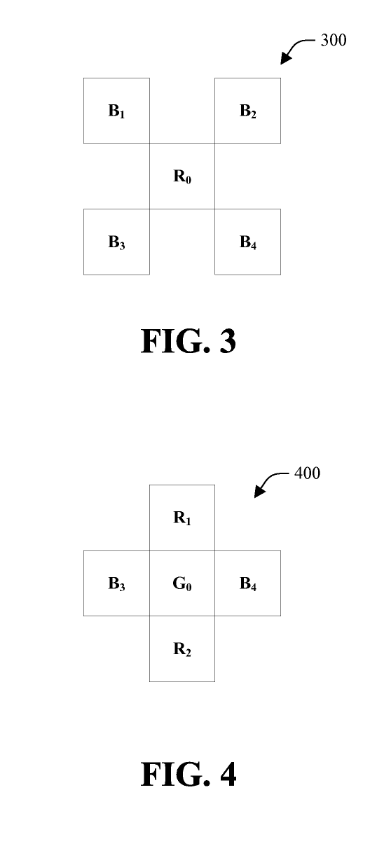

Described below is a prior procedure that can be performed, which provides more information and more direction choices for the subsequent procedure. As was observed above, there is no vertical or horizontal adjacent pixel with the same channel at the B/R pixel location if R/B has to be interpolated. R/B estimates at B/R pixel location are interpolated using information from their closest neighbors. Interpolation is performed in K_{b} and Kᵣ spaces. For instance, referring to FIG. 3, B₀″ is interpolated using B₁, B₂, B₃, B₄, and the interpolated G″ values. K_{b} at the center is the average of the four K_{b}. That is,

$${K}_{b 0} = \frac{{K}_{b 1} + {K}_{b 2} + {K}_{b 3} + {K}_{b 4}}{4} \qquad Eq . 11$$

B₀″^{V} and B₀″^{H} are computed as

$$\begin{matrix}{B}_{0}^{″ V} = \frac{{B}_{1} + {B}_{2} + {B}_{3} + {B}_{4}}{4} + {G}_{0}^{″ V} - \frac{{G}_{1}^{″ V} + {G}_{2}^{″ V} + {G}_{3}^{″ V} + {G}_{4}^{″ V}}{4} & Eq . 12 \\ {B}_{0}^{″ H} = \frac{{B}_{1} + {B}_{2} + {B}_{3} + {B}_{4}}{4} + {G}_{0}^{″ H} - \frac{{G}_{1}^{″ H} + {G}_{2}^{″ H} + {G}_{3}^{″ H} + {G}_{4}^{″ H}}{4} & Eq . 13\end{matrix}$$

When it comes to the interpolation of R/B at the G pixel location, since interpolated R/B values were obtained at the B/R pixel location in the previous procedure, there are vertical and horizontal neighbors of R/B. Thus, R/B at the G pixel location can be interpolated vertically or horizontally. Interpolation is also performed in K_{b} and Kᵣ spaces in this procedure. For instance, referring to FIG. 4, with a array of pixels 400, K_{b} is estimated vertically and horizontally by

$${K}_{b 0} = [ \frac{\frac{{K}_{b 1} + {K}_{b 2}}{2}}{\frac{{K}_{b 3} + {K}_{b 4}}{2}} \frac{For Vertical}{For Horizontal} \qquad Eq . 14$$

The B₀″^{V} and B₀″^{H} are interpolated by

$${B}_{0}^{″ V} = {G}_{0}^{″ V} - \frac{( {G}_{1}^{″ V} - {B}_{1}^{″ V} ) + ( {G}_{2}^{″ V} - {B}_{2}^{″ V} )}{2} \qquad Eq . 15$$

$$And {B}_{0}^{″ H} = {G}_{0}^{″ H} - \frac{( {G}_{3}^{″ H} - {B}_{3}^{″} ) + ( {G}_{4}^{″ H} - {B}_{4} )}{2} \qquad Eq . 16$$

The R channel at G pixel locations can be calculated in a similar manner.

After computing all the missing elements R^{H}, G^{H}, and B^{H} in vertical and horizontal directions, interpolation values with the same direction at each pixel location are regarded as a direction vector. That is, (R^{V}, G^{V}, B^{V}) and (R^{H}, G^{H}, B^{H}) are the two direction vectors at each pixel. A direction vector is selected by comparing vector differences between neighbors for each pixel location in accordance with one exemplary non-limiting embodiment. Vector difference is used as a criterion for choosing the direction for interpolation results because considering R, G, and B together as a vector ensures greater direction consistency and greatly reduces the color artifacts.

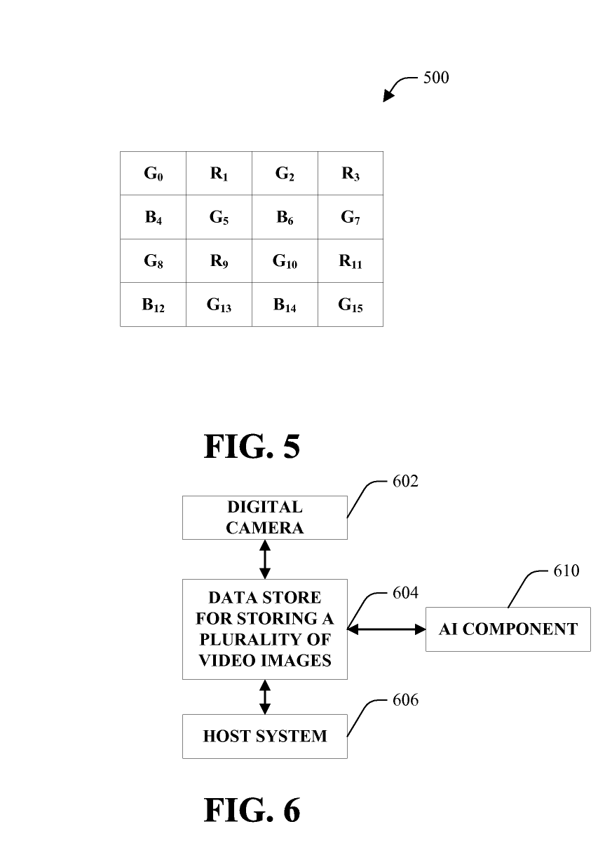

In one embodiment, the selection process is performed from left to right and from top to bottom for each pixel location. The direction with the smaller vector difference is selected and the selected direction vector will be the confirmed vector at the pixel location. When calculating the vector differences, the confirmed vectors are used for the top candidate of the vertical vector difference and the left candidate of the horizontal vector differences. For example, referring to FIG. 5, the vertical (V) and horizontal (H) vector difference at G₅ are

V=∥(R₅^{V},G₅^{V},B₅^{V})−(R₁,G₁,B₁)∥+∥(R₅^{V},G₅^{V},B₅^{V})−(R₉^{V},G₉^{V},B₉^{V})∥ Eq. 17

And

H=∥(R₅^{H},G₅^{H},B₅^{H})−(R₄,G₄,B₄)∥+∥(R₅^{H},G₅^{H},B₅^{H})−(R₆^{H},G₆^{H},B₆^{H})∥ Eq. 18

If V<H, it is more likely that an edge is along the vertical direction. Thus, (R₅^{V}, G₅^{V}, B₅^{V}) is selected. Otherwise, under such circumstances, selecting horizontal vector (R₅^{H}, G₅^{H}, B₅^{H}) is a better choice. After selecting the direction vector for the current pixel location, the confirmed vector (R, G, B) will be set as the selected direction vector. In the above example, (R₅, G₅, B₅)=(B₅^{V}, G₅^{V}, B₅^{V}) if V<H. This ensures the use of the most updated information for the selection process of the next pixel. The reconstructed image is obtained after selecting all the direction vectors for each pixel.

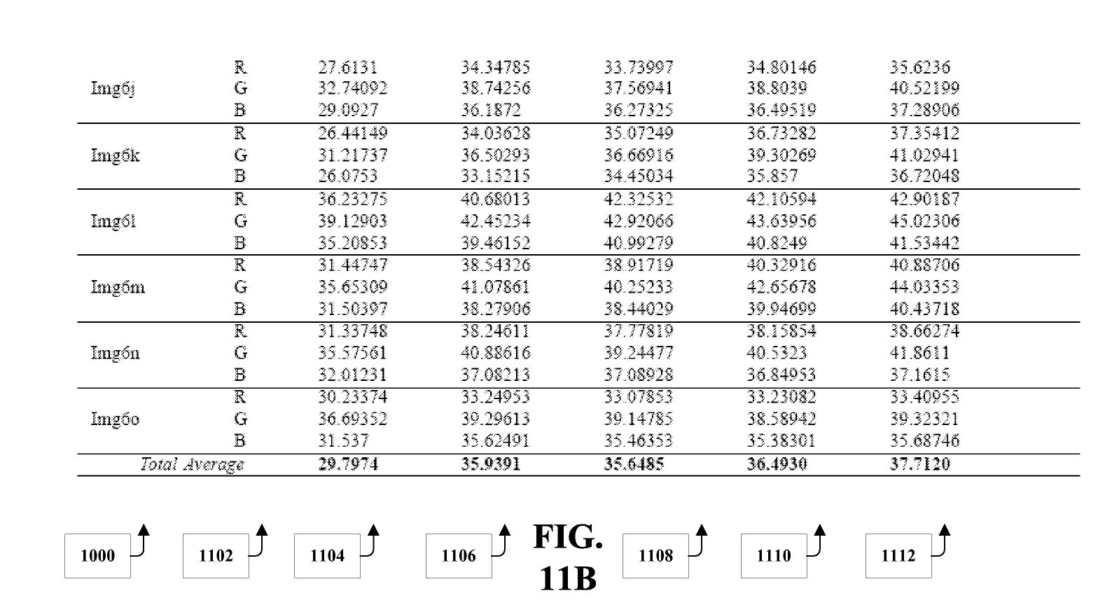

One embodiment as herein disclosed was tested and compared with bilinear interpolation and various other conventional methods using an image set. The images are initially filtered with a Bayer CFA and then the demosaicking approaches are applied. The peak-signal-to-noise ratios (PSNRs) of interpolation results are computed as an objective measurement for comparison. The results are shown in FIGS. 11A and 11B wherein image names are in column 1000, the colors (R,G,B,) are in column 1102, the PSNRs of the bilinear method are in column 1104, the PSNRs of another conventional method are in column 1106, the PSNRs of another conventional method are in column 1108, the PSNRs of the another conventional method are in column 1110, and the PSNRs of one exemplary method described herein are at column 1112. As can be seen, the herein described methods and apparatus provide for PSNRs that are higher than conventional methods.

Bilinear interpolation is known as a simple method that performs poorly. The poor quality of its interpolation results are demonstrated in FIGS. 11A and 11B and in the reconstructed images (not shown). The approach using signal correlation (SC) also performs interpolation in Kᵣ and K_{b} space, but it performs simple neighbor averaging of Kᵣ and K_{b} without considering whether they belong to the same object. Color artifacts can be found at the edge of objects especially places with large variation of Kᵣ/K_{b}. Edge-sensing (ES) has been proposed to detect edges and apply adaptive interpolation, but it does not maintain the direction consistency. Therefore, it induces many color artifacts in the reconstructed images. While the primary consistent soft-decision (PCSD) approach maintains direction consistency during interpolation, the methods described herein outperform PCSD due to the use of an improved filter for interpolation. Further, the herein described methods and apparatus direction vector selection processes maintain direction consistency and minimize the color artifacts. Even without any numerical comparison, the better visual quality of reconstructed images using the herein described methods can be observed in the images. The average PSNR of reconstructed images obtained by the herein described embodiments is higher than the average PSNR of PCSD by about 1 dB and is higher than the average PSNR of bilinear interpolation methods by about 7 dB higher.

FIG. 5 illustrates a digital camera 602 including a data store 604 for storing a plurality of video images including both stationary and moving images. A host system 606 is coupled to the data store and processes raw data received from the three charge-coupled devices (CCD) to capture digital images with red (R), green (G), and blue (B) colors. The host system can perform the demosaicking operations as herein described. An AI component 610 can be included to facilitate determining whether to use the horizontal interpolation or the vertical interpolation in one embodiment. In another embodiment, the AI component can be employed in the direction vector selection process.

In one embodiment, the employ of artificial intelligence (AI) component is done. The AI component can be employed to facilitate inferring and/or determining when, where, and/or how to dynamically vary any variable parameter, such as which demosaicking method or process to employ on a given set of raw data. Such inference results in the construction of new events or actions from a set of observed events and/or stored event data, whether or not the events are correlated in close temporal proximity, and whether the events and data come from one or several event and data sources.

The AI component can also employ any of a variety of suitable AI-based schemes in connection with facilitating various aspects of the herein described innovation. For example, and in the context of a consumer of the digital camera and the user is using a server to store image data, a process for learning explicitly or implicitly how to demosiack raw image data can be facilitated via an automatic classification system and process. Classification can employ a probabilistic and/or statistical-based analysis (e.g., factoring into the analysis utilities and costs) to prognose or infer an action that a user desires to be automatically performed.

For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

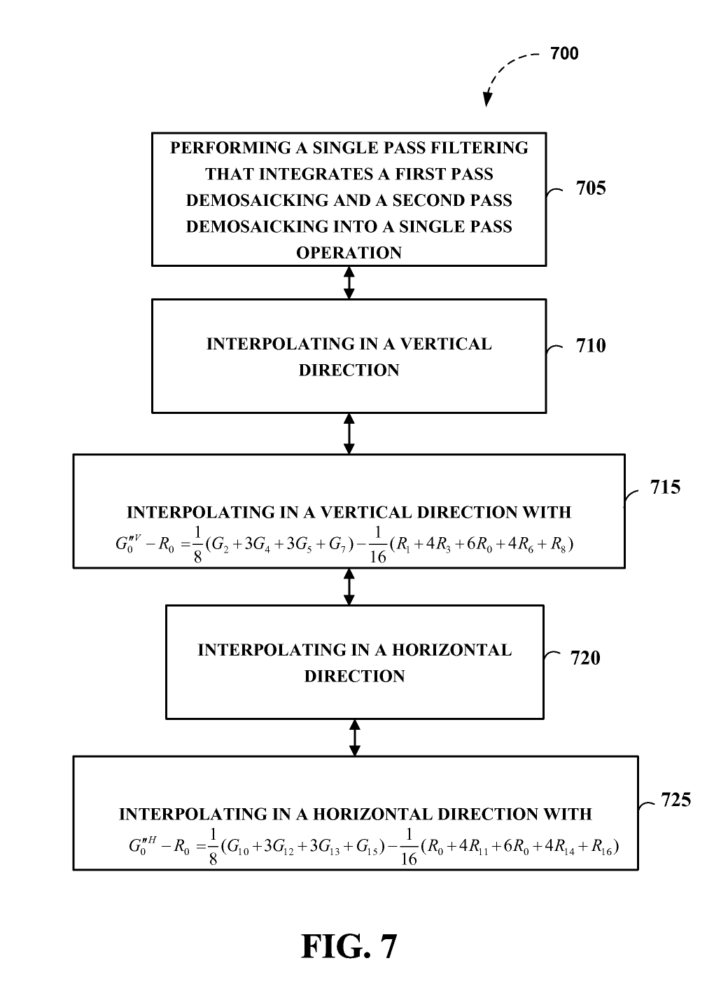

FIG. 7 illustrates a methodology 700 including performing a single pass filtering that integrates a first pass demosaicking and a second pass demosaicking into a single pass operation at 705. At 710, interpolation is performed in a vertical direction. At 715, interpolation is performed in a vertical direction with

$${G}_{0}^{″ V} - {R}_{0} = \frac{1}{8} ( {G}_{2} + 3 {G}_{4} + 3 {G}_{5} + {G}_{7} ) - \frac{1}{16} ( {R}_{1} + 4 {R}_{3} + 6 {R}_{0} + 4 {R}_{6} + {R}_{8} ) . At 720 ,$$

interpolation is performed in a horizontal direction. At 725, interpolations is performed in a horizontal direction with

$${G}_{0}^{″ H} - {R}_{0} = \frac{1}{8} ( {G}_{10} + 3 {G}_{12} + 3 {G}_{13} + {G}_{15} ) - \frac{1}{16} ( {R}_{0} + 4 {R}_{11} + 6 {R}_{0} + 4 {R}_{14} + {R}_{16} ) .$$

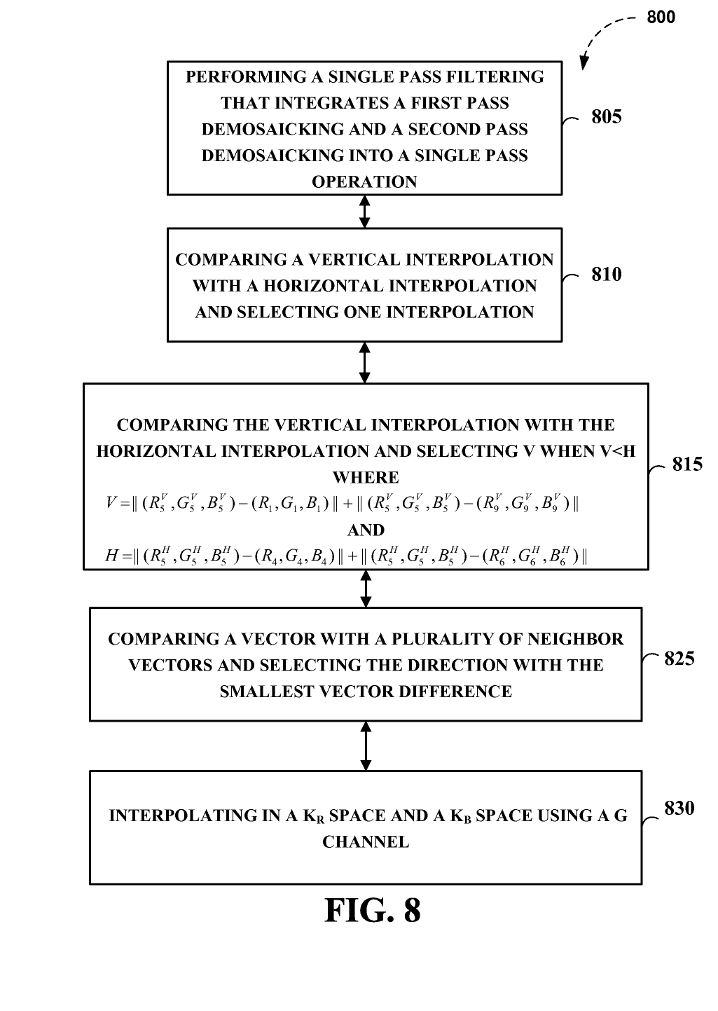

FIG. 8 illustrates a methodology 800 including performing a single pass filtering that integrates a first pass demosaicking and a second pass demosaicking into a single pass operation at 805. At 810, the vertical interpolation is compared with the horizontal interpolation and either the horizontal or vertical interpolation is selected. At 815, the vertical interpolation is compared with the horizontal interpolation and V is selected when V<H where V=∥(R₅^{V}, G₅^{V}, B₅^{V})−(R₁, G₁, B₁)∥+∥(R₅^{V}, G₅^{V}, B₅^{V})−(R₉^{V}, G₉^{V}, B₉^{V})∥ and H=∥(R₅^{H}, G₅^{H}, B₅^{H})−(R₄, G₄, B₄)∥+∥(R₅^{H}, G₅^{H}, B₅^{H})−(R₆^{H}, G₆^{H}, B₆^{H})∥. At 825, a vector is compared with a plurality of neighbor vectors and the direction with the smallest vector difference is selected. At 830, interpolation is performed in a Kᵣ space and a K_{b} space using a G channel. Because the PSNR is improved, the images are better and facial recognition is improved. Therefore, casinos in Monte Carlo and Las Vegas, for example, can employ the herein described demosaicking in coordination with face recognition systems to better exclude unwanted customers. The AI component can also be employed with the demosaicking and the facial recognition. Additionally, terrorists, or other so called enemies of state, may be better identified with the herein described demosaicking in coordination with a face recognition system at an airport or other transportation center such as a train or bus station.

### Exemplary Computer Networks and Environments

One of ordinary skill in the art can appreciate that the innovation can be implemented in connection with any computer or other client or server device, which can be deployed as part of a computer network, or in a distributed computing environment, connected to any kind of data store. In this regard, the present innovation pertains to any computer system or environment having any number of memory or storage units, and any number of applications and processes occurring across any number of storage units or volumes, which may be used in connection with optimization algorithms and processes performed in accordance with the present innovation. The present innovation may apply to an environment with server computers and client computers deployed in a network environment or a distributed computing environment, having remote or local storage. The present innovation may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the optimization algorithms and processes of the innovation.

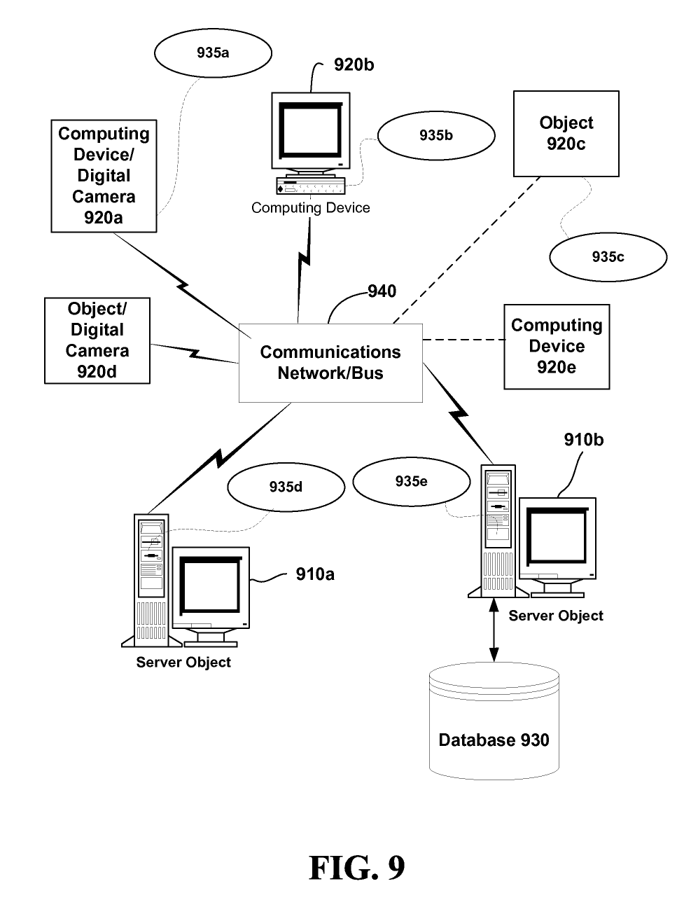

FIG. 9 provides a schematic diagram of an exemplary networked or distributed computing environment. The distributed computing environment comprises computing objects 910a, 910b, etc. and computing objects or devices 920a, 920b, 920c, 920d, 920e, etc. These objects may comprise programs, methods, data stores, programmable logic, etc. The objects may comprise portions of the same or different devices such as PDAs, audio/video devices, MP3 players, digital cameras, personal computers, etc. Each object can communicate with another object by way of the communications network 940. This network may itself comprise other computing objects and computing devices that provide services to the system of FIG. 9, and may itself represent multiple interconnected networks. In accordance with an aspect of the innovation, each object 910a, 910b, etc. or 920a, 920b, 920c, 920d, 920e, etc. may contain an application that might make use of an API, or other object, software, firmware and/or hardware, suitable for use with the design framework in accordance with the innovation.

It can also be appreciated that an object, such as 920c, may be hosted on another computing device 910a, 910b, etc. or 920a, 920b, 920c, 920d, 920e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to optimization algorithms and processes according to the present innovation.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11 A/B/G) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DV1 are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present innovation may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 9, as an example, digital cameras/computers 920a, 920b, 920c, 920d, 920e, etc. can be thought of as clients and computers 910a, 910b, etc. can be thought of as servers where servers 910a, 910b, etc. maintain the data that is then replicated to client computers 920a, 920b, 920c, 920d, 920e, etc., although any computer can be considered a client, a server, or both, depending on the circumstances. Any of these computing devices may be processing data or requesting services or tasks that may implicate the optimization algorithms and processes in accordance with the innovation.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the optimization algorithms and processes of the innovation may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 9 illustrates an exemplary networked or distributed environment, with server(s) in communication with client computer (s) via a network/bus, in which the present innovation may be employed. In more detail, a number of servers 910a, 910b, etc. are interconnected via a communications network/bus 940, which may be a LAN, WAN, intranet, GSM network, the Internet, etc., with a number of client or remote computing devices/digital cameras 920a, 920b, 920c, 920d, 920e, etc., such as a portable computer, handheld computer, thin client, networked appliance, or other device, such as a VCR, TV, oven, light, heater and the like in accordance with the present innovation. It is thus contemplated that the present innovation may apply to any computing device in connection with which it is desirable to communicate data over a network or standalone device that does not connect to anything else.

In a network environment in which the communications network/bus 940 is the Internet, for example, the servers 910a, 910b, etc. can be Web servers with which the clients 920a, 920b, 920c, 920d, 920e, etc. communicate via any of a number of known protocols such as HTTP. Servers 910a, 910b, etc. may also serve as clients 920a, 920b, 920c, 920d, 920e, etc., as may be characteristic of a distributed computing environment.

As mentioned, communications may be wired or wireless, or a combination, where appropriate. Client devices 920a, 920b, 920c, 920d, 920e, etc. may or may not communicate via communications network/bus 14, and may have independent communications associated therewith. For example, in the case of a TV or VCR, there may or may not be a networked aspect to the control thereof. Each client computer 920a, 920b, 920c, 920d, 920e, etc. and server computer 910a, 910b, etc. may be equipped with various application program modules or objects 935a, 935b, 935c, etc. and with connections or access to various types of storage elements or objects, across which files or data streams may be stored or to which portion(s) of files or data streams may be downloaded, transmitted or migrated. Any one or more of computers 910a, 910b, 920a, 920b, 920c, 920d, 920e, etc. may be responsible for the maintenance and updating of a database 930 or other storage element, such as a database or memory 930 for storing data processed or saved according to the innovation. Thus, the present innovation can be utilized in a computer network environment having client computers 920a, 920b, 920c, 920d, 920e, etc. that can access and interact with a computer network/bus 940 and server computers 910a, 910b, etc. that may interact with client computers 920a, 920b, 920c, 920d, 920e, etc. and other like devices, and databases 930.

### Exemplary Digital Camera/Computing Device

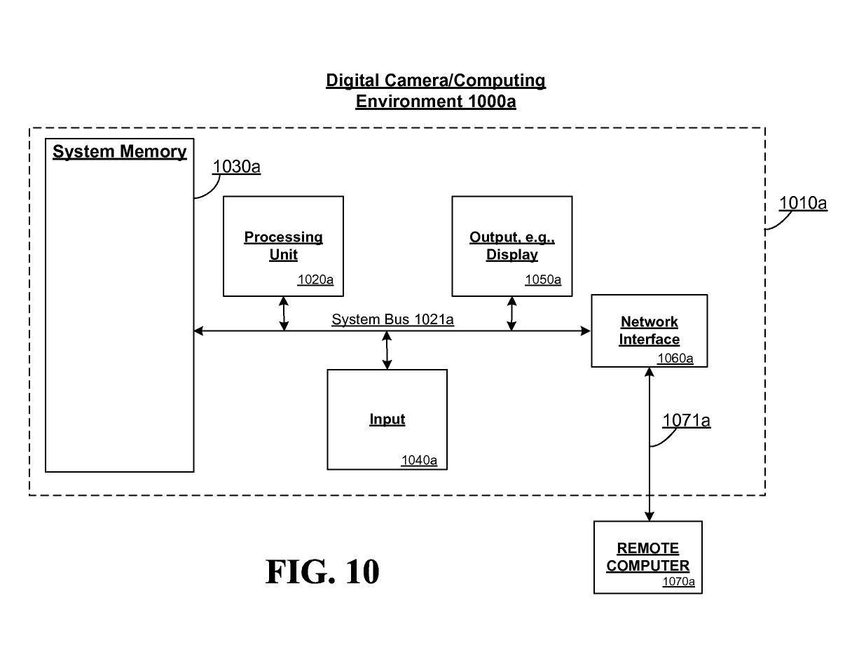

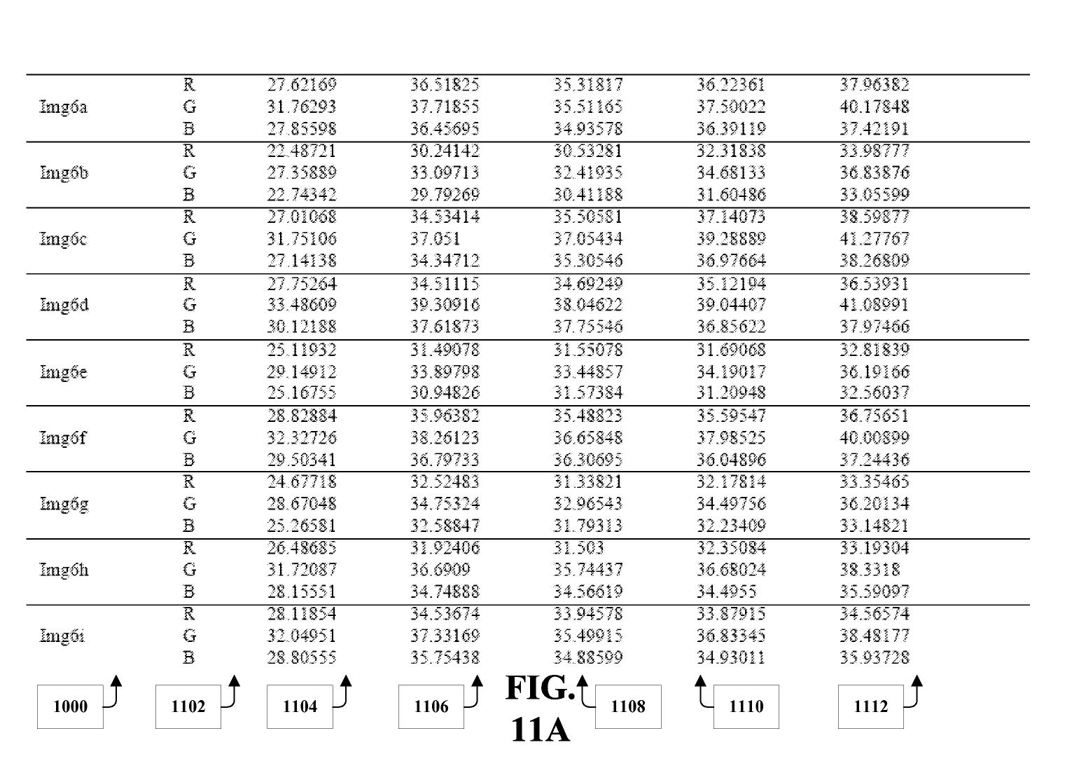

As mentioned, the innovation applies to any device wherein it may be desirable to communicate data, e.g., to a mobile device. It should be understood, therefore, that handheld, portable and other computing devices and computing objects of all kinds are contemplated for use in connection with the present innovation, i.e., anywhere that a device may communicate data or otherwise receive, process or store data. Accordingly, the below general purpose remote computer described below in FIG. 10 is but one example, and the present innovation may be implemented with any client having network/bus interoperability and interaction. Thus, the present innovation may be implemented in an environment of networked hosted services in which very little or minimal client resources are implicated, e.g., a networked environment in which the client device serves merely as an interface to the network/bus, such as an object placed in an appliance.

Although not required, the innovation can partly be implemented via an operating system, for use by a developer of services for a device or object, and/or included within application software that operates in connection with the component(s) of the innovation. Software may be described in the general context of computer executable instructions, such as program modules, being executed by one or more computers, such as client workstations, servers or other devices. Those skilled in the art will appreciate that the innovation may be practiced with other computer system configurations and protocols.

FIG. 10 thus illustrates an example of a suitable digital camera/computing system environment 1000a in which the innovation may be implemented, although as made clear above, the computing system environment 1000a is only one example of a suitable computing environment for a media device and is not intended to suggest any limitation as to the scope of use or functionality of the innovation. Neither should the computing environment 1000a be interpreted as having any dependency or requirement relating to any one or combination of components illustrated in the exemplary operating environment 1000a.

With reference to FIG. 10, an exemplary remote device for implementing the innovation includes a general purpose computing device in the form of a computer 1010a. Components of computer 1010a may include, but are not limited to, a processing unit 1020a, a system memory 1030a, and a system bus 1021a that couples various system components including the system memory to the processing unit 1020a. The system bus 1021a may be any of several types of bus structures including a memory bus or memory controller, a peripheral bus, and a local bus using any of a variety of bus architectures.

Computer 1010a typically includes a variety of computer readable media. Computer readable media can be any available media that can be accessed by computer 1010a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1010a. Communication media typically embodies computer readable instructions, data structures, program modules or other data in a modulated data signal such as a carrier wave or other transport mechanism and includes any information delivery media.

The system memory 1030a may include computer storage media in the form of volatile and/or nonvolatile memory such as read only memory (ROM) and/or random access memory (RAM). A basic input/output system (BIOS), containing the basic routines that help to transfer information between elements within computer 1010a, such as during start-up, may be stored in memory 1030a. Memory 1030a typically also contains data and/or program modules that are immediately accessible to and/or presently being operated on by processing unit 1020a. By way of example, and not limitation, memory 1030a may also include an operating system, application programs, other program modules, and program data.

The computer 1010a may also include other removable/non-removable, volatile/nonvolatile computer storage media. For example, computer 1010a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1021a through a non-removable memory interface such as an interface, and a magnetic disk drive or optical disk drive is typically connected to the system bus 1021a by a removable memory interface, such as an interface.

A user may enter commands and information into the computer 1010a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1020a through user input 1040a and associated interface(s) that are coupled to the system bus 1021a, but may be connected by other interface and bus structures, such as a parallel port, game port or a universal serial bus (USB). A graphics subsystem may also be connected to the system bus 1021a. A monitor or other type of display device is also connected to the system bus 1021a via an interface, such as output interface 1050a, which may in turn communicate with video memory. In addition to a monitor, computers may also include other peripheral output devices such as speakers and a printer, which may be connected through output interface 1050a.

The computer 1010a may operate in a networked or distributed environment using logical connections to one or more other remote computers, such as remote computer 1070a, which may in turn have media capabilities different from device 1010a. The remote computer 1070a may be a personal computer, a digital camera, a server, a router, a network PC, a peer device or other common network node, or any other remote media consumption or transmission device, and may include any or all of the elements described above relative to the computer 1010a. The logical connections depicted in FIG. 10 include a network 1071a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1010a is connected to the LAN 1071a through a network interface or adapter. When used in a WAN networking environment, the computer 1010a typically includes a communications component, such as a modem, or other means for establishing communications over the WAN, such as the Internet. A communications component, such as a modem, which may be internal or external, may be connected to the system bus 1021a via the user input interface of input 1040a, or other appropriate mechanism. In a networked environment, program modules depicted relative to the computer 1010a, or portions thereof, may be stored in a remote memory storage device. It will be appreciated that the network connections shown and described are exemplary and other means of establishing a communications link between the computers may be used.

While the present innovation has been described in connection with the preferred embodiments of the various Figures, it is to be understood that other similar embodiments may be used or modifications and additions may be made to the described embodiment for performing the same function of the present innovation without deviating therefrom. For example, one skilled in the art will recognize that the present innovation as described in the present application may apply to any environment, whether wired or wireless, and may be applied to any number of such devices connected via a communications network and interacting across the network. Therefore, the present innovation should not be limited to any single embodiment, but rather should be construed in breadth and scope in accordance with the appended claims.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the innovation described herein may have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present innovation, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the innovation. In the case of program code execution on programmable computers, the computing device generally includes a processor, a storage medium readable by the processor (including volatile and non-volatile memory and/or storage elements), at least one input device, and at least one output device.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to digital cameras, magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the various flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present innovation has been described in connection with the preferred embodiments of the various figures, it is to be understood that other similar embodiments may be used or modifications and additions may be made to the described embodiment for performing the same function of the present innovation without deviating therefrom.

While exemplary embodiments refer to utilizing the present innovation in the context of particular programming language constructs, specifications or standards, the innovation is not so limited, but rather may be implemented in any language to perform the optimization algorithms and processes. Still further, the present innovation may be implemented in or across a plurality of processing chips or devices, and storage may similarly be effected across a plurality of devices. Therefore, the present innovation should not be limited to any single embodiment, but rather should be construed in breadth and scope in accordance with the appended claims.

What is claimed is:

1. A method comprising performing a single pass filtering on image data that integrates a first pass demosaicking process over the image data and a second pass demosaicking process over the image data into a single pass operation.

2. A method in accordance with claim 1 further comprising interpolating in a vertical direction.

3. A method in accordance with claim 2 further comprising interpolating in a vertical direction with
$${G}_{0}^{″ V} - {R}_{0} = \frac{1}{8} ( {G}_{2} + 3 {G}_{4} + 3 {G}_{5} + {G}_{7} ) - \frac{1}{16} ( {R}_{1} + 4 {R}_{3} + 6 {R}_{0} + 4 {R}_{6} + {R}_{8} ) .$$

4. A method in accordance with claim 2 further comprising interpolating in a horizontal direction.

5. A method in accordance with claim 2 further comprising interpolating in a horizontal direction with
$${G}_{0}^{″ H} - {R}_{0} = \frac{1}{8} ( {G}_{10} + 3 {G}_{12} + 3 {G}_{13} + {G}_{15} ) - \frac{1}{16} ( {R}_{0} + 4 {R}_{11} + 6 {R}_{0} + 4 {R}_{14} + {R}_{16} ) .$$

6. A method in accordance with claim 5 further comprising comparing the vertical interpolation with the horizontal interpolation and selecting one interpolation.

7. A method in accordance with claim 5 further comprising comparing the vertical interpolation with the horizontal interpolation and selecting V when V<H.

8. A method in accordance with 7 further comprising comparing a vector with a plurality of neighbor vectors and selecting the direction with the smallest vector difference.

9. A method in accordance with 1 further comprising comparing a vector with a plurality of neighbor vectors and selecting the direction with the smallest vector difference.

10. A digital camera, comprising:
at least one data store for storing a plurality of video images; and
a host system that processes the video images by performing a single pass filtering that integrates a first pass demosaicking and a second pass demosaicking into a single simple pass (SP) filtering operation.

11. A digital camera in accordance with claim 10 wherein the host system interpolates in a vertical direction with
$${G}_{0}^{″ V} - {R}_{0} = \frac{1}{8} ( {G}_{2} + 3 {G}_{4} + 3 {G}_{5} + {G}_{7} ) - \frac{1}{16} ( {R}_{1} + 4 {R}_{3} + 6 {R}_{0} + 4 {R}_{6} + {R}_{8} ) .$$

12. A digital camera in accordance with claim 11 wherein the host system interpolates in a horizontal direction with
$${G}_{0}^{″ H} - {R}_{0} = \frac{1}{8} ( {G}_{10} + 3 {G}_{12} + 3 {G}_{13} + {G}_{15} ) - \frac{1}{16} ( {R}_{0} + 4 {R}_{11} + 6 {R}_{0} + 4 {R}_{14} + {R}_{16} ) .$$

13. A digital camera in accordance with claim 12 wherein the host system compares the vertical interpolation with the horizontal interpolation and selects one interpolation.

14. A digital camera in accordance with claim 13 wherein the host system compares a vector with a plurality of neighbor vectors and selecting the direction with the smallest vector difference.

15. A digital camera in accordance with claim 10 wherein the host system compares a vertical interpolation with a horizontal interpolation and selects one interpolation.

16. A digital camera in accordance with claim 15 wherein the host system compares a vector with a plurality of neighbor vectors and selecting the direction with the smallest vector difference.

17. A digital camera in accordance with claim 10 wherein the host system interpolates in a Kᵣ space and a K_{b} space using a G channel.

18. Apparatus comprising:
means for receiving video data;
means for performing a horizontal interpolation on the video data;
means for performing a vertical interpolation and selecting one interpolation over the other interpolation; and
means for selecting a direction to perform a demosaicking operation on the video data.

19. Apparatus in accordance with claim 18 further comprising means for performing a horizontal interpolation using
$${G}_{0}^{″ H} - {R}_{0} = \frac{1}{8} ( {G}_{10} + 3 {G}_{12} + 3 {G}_{13} + {G}_{15} ) - \frac{1}{16} ( {R}_{0} + 4 {R}_{11} + 6 {R}_{0} + 4 {R}_{14} + {R}_{16} ) .$$

20. Apparatus in accordance with claim 18 further comprising means for performing a vertical interpolation using
$${G}_{0}^{″ V} - {R}_{0} = \frac{1}{8} ( {G}_{2} + 3 {G}_{4} + 3 {G}_{5} + {G}_{7} ) - \frac{1}{16} ( {R}_{1} + 4 {R}_{3} + 6 {R}_{0} + 4 {R}_{6} + {R}_{8} ) .$$
